(19) United States
(12) Patent Application Publication
(10) Pub. No.: US 2022/0240293 A1
(43) Pub. Date: Jul. 28, 2022

(54) UE CAPABILITY OF BFD RS PER BEAM GROUP

(71) Applicant: QUALCOMM Incorporated, San Diego, CA (US)

(72) Inventors: Tianyang BAI, Somerville, NJ (US); Yan ZHOU, San Diego, CA (US); Tao LUO, San Diego, CA (US); Junyi LI, Fairless Hills, PA (US)

(21) Appl. No.: 17/455,406

(22) Filed: Nov. 17, 2021

Related U.S. Application Data
(60) Provisional application No. 63/141,384, filed on Jan. 25, 2021.

(51) Int. Cl. H04W 72/12; H04W 24/08

(52) U.S. Cl. CPC H04W 72/1289; H04W 24/08

(57) ABSTRACT

Apparatus, methods, and computer program products for per beam group BFR RS are provided. An example method includes receiving, from a base station, a per beam group beam failure recovery (BFR) configuration comprising one or more beam failure detection (BFD) reference signal (RS) per beam group based on one or more of: a maximum number of BFD RS sets supported by the UE, a maximum number of BFD RS per set that is supported by the UE, or a maximum number of total BFD RS across each set that is supported by the UE. The example method measuring reference signal received power (RSRP) of the one or more BFD RS at a beam group based on the per beam group BFR configuration for a TRP.

### CROSS-REFERENCE TO RELATED APPLICATION(S)

This application claims the benefit of U.S. Provisional Application Ser. No. 63/141,384, entitled “UE CAPABILITY OF BFD RS PER BEAM GROUP” and filed on Jan. 25, 2021, which is expressly incorporated by reference herein in its entirety.

### BACKGROUND

### Technical Field

The present disclosure relates generally to communication systems, and more particularly, to wireless communication systems with beam failure recovery (BFR).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at user equipment (UE) comprising one or more transmission and reception points (TRPs) and one or more beam groups are provided. The UE may receive, from a base station, a per beam group beam failure recovery (BFR) configuration comprising one or more beam failure detection (BFD) reference signal (RS) per beam group based on one or more of: a maximum number of BFD RS sets supported by the UE, a maximum number of BFD RS per set that is supported by the UE, or a maximum number of total BFD RS across each set that is supported by the UE. The UE may measure reference signal received power (RSRP) of the one or more BFD RS at a beam group based on the per beam group BFR configuration for a TRP.

In another aspect of the disclosure, a method, a computer-readable medium, and an apparatus at a base station are provided. The base station may transmit, to a UE comprising one or more TRPs and one or more beam groups, a per beam group BFR configuration comprising one or more BFD RS per TRP based on one or more of: a supported maximum number of BFD RS set of the UE, a supported maximum number of BFD RS per set of the UE, or a supported maximum number of total BFD RS across each set of the UE. The base station may receive a BFR request associated with a beam group from the UE based on the BFR configuration for the beam group.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating examples of UEs having multiple TRPs.

FIG. 5 is a diagram illustrating a base station in communication with a UE via multiple beams.

FIG. 6 is a call flow diagram of signaling between a UE and a base station.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

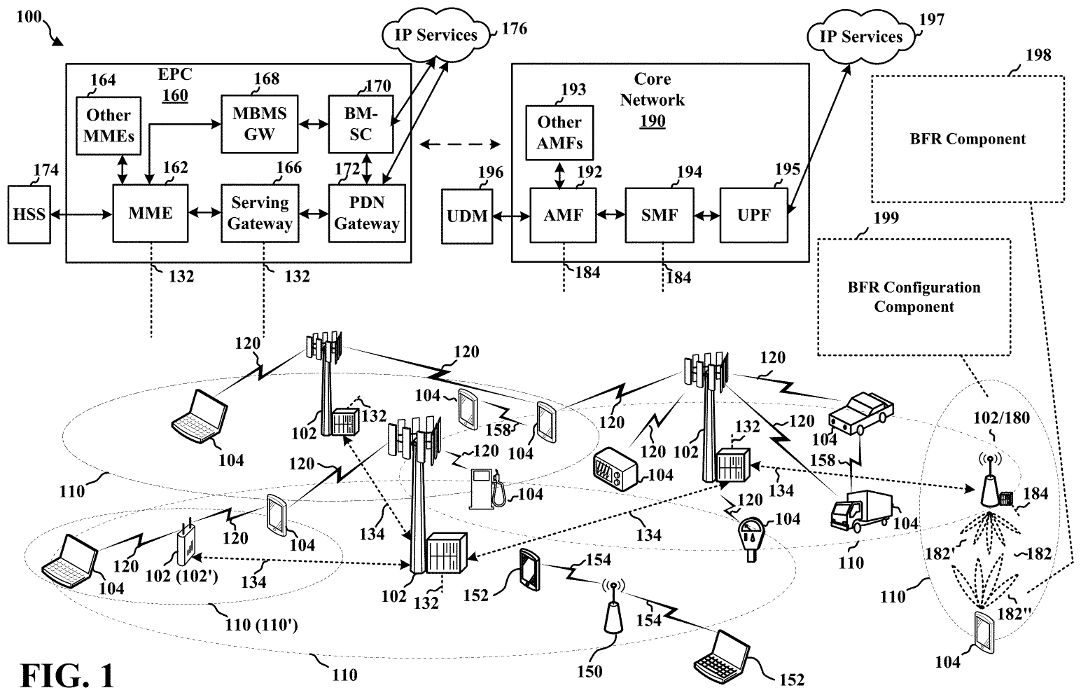

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a BFR component 198 configured to receive, from a base station, a per beam group BFR configuration comprising one or more BFD RS per beam group based on one or more of: a maximum number of BFD RS sets supported by the UE, a maximum number of BFD RS per set that is supported by the UE, or a maximum number of total BFD RS across each set that is supported by the UE. The BFR component 198 may be further configured to measure RSRP of the one or more BFD RS at a beam group based on the per beam group BFR configuration for a TRP. In some aspects, the base station 102/180 may include a BFR configuration component 199 configured to transmit, to a UE comprising one or more TRPs and one or more beam groups, a per beam group BFR configuration comprising one or more BFD RS per TRP based on one or more of: a supported maximum number of BFD RS set of the UE, a supported maximum number of BFD RS per set of the UE, or a supported maximum number of total BFD RS across each set of the UE. The BFR configuration component 199 may be further configured to receive a BFR request associated with a beam group from the UE based on the BFR configuration for the beam group.

Although the following description may be focused on 5G NR, the concepts described herein may be applicable to other similar areas, such as LTE, LTE-A, CDMA, GSM, and other wireless technologies.

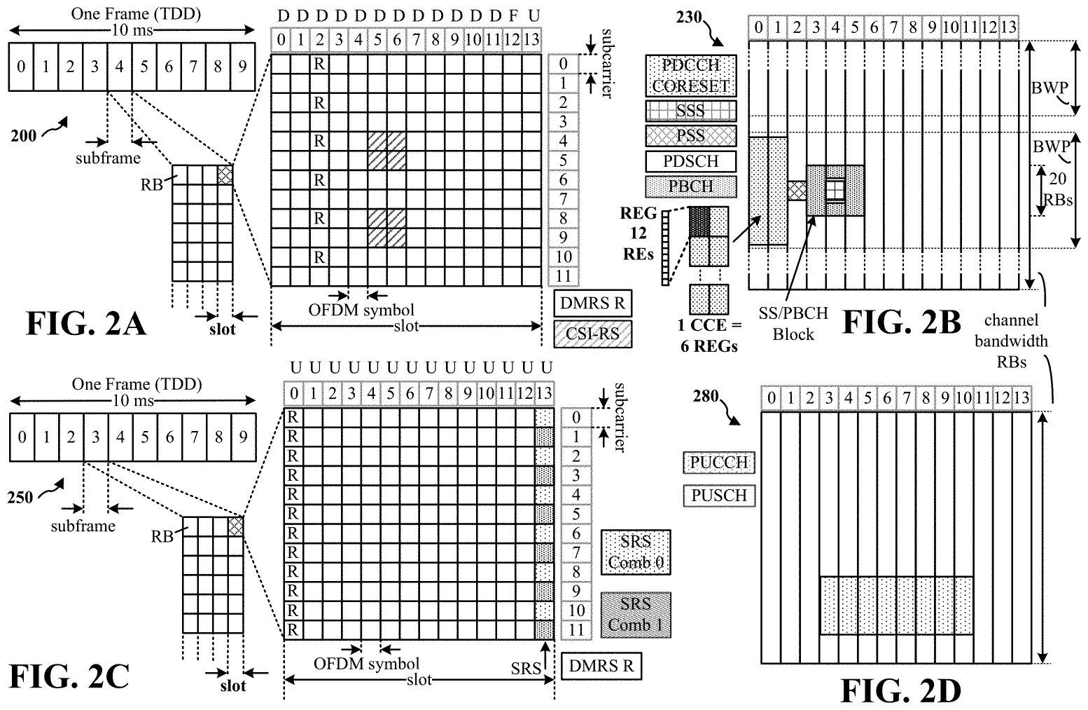

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

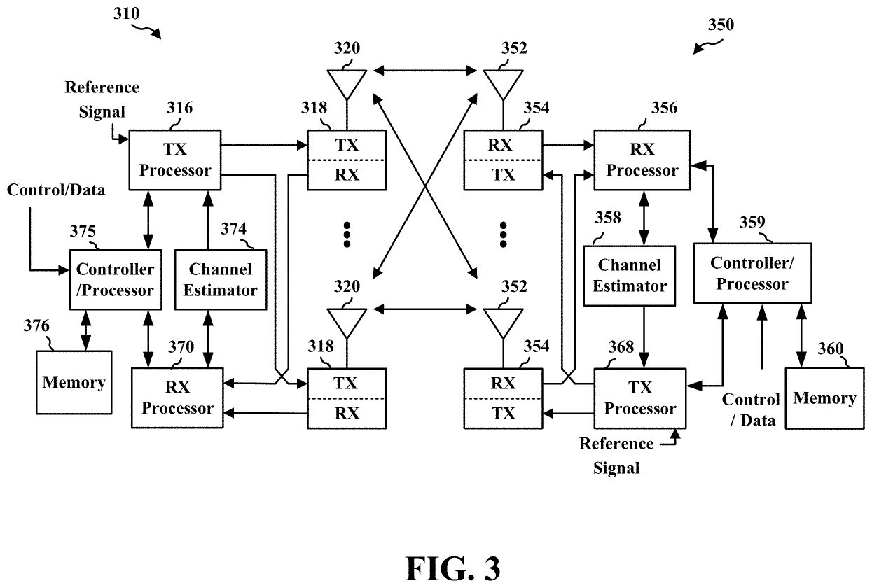

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

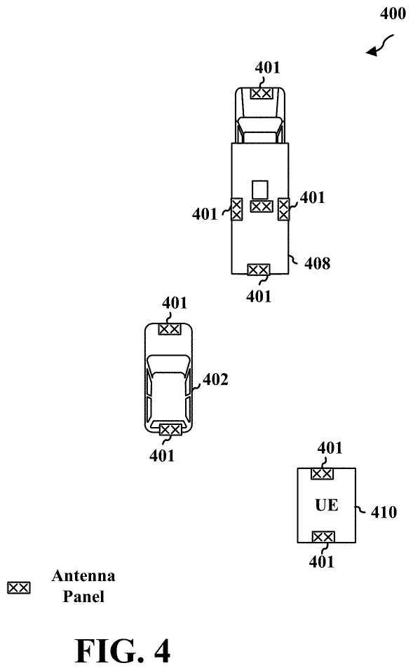

A UE may include multiple TRPs. Each TRP comprises different RF modules having a shared hardware and/or software controller. Each TRP may perform separate baseband processing. Each TRP may comprise a different antenna panel or a different set of antenna elements of a UE. As one non-limiting example of a UE with multiple TRPs, a vehicle UE may have multiple antenna panels, such as a front antenna panel and a rear antenna panel. Larger vehicles may have more than two TRPs. FIG. 4 is a diagram illustrating examples of UEs 402, 408, and 410 having multiple TRPs 401. For example, UEs 402 and 410 may have two TRPs 401, e.g., a front antenna panel and a rear antenna panel. The UE 408 may be a larger vehicle having more than two TRPs 401. The TRPs of the UE may be physically separated. For example, TRPs on a vehicle may be located at different locations of the vehicle. As an example, front and rear antenna panels on a vehicle may be separated by 3 meters, 4 meters, etc. Although a UE associated with a vehicle is given as one example, the aspects presented herein are applicable to various types of UEs. The spacing between TRPs may vary. Each of the TRPs may experience a channel differently (e.g., experience a different channel quality) due to the different physical location, the distance between the TRPs, different line-of-sight (LOS) characteristics (e.g., a LOS channel in comparison to a non-LOS (NLOS) channel), blocking/obstructions, interference from other transmissions, among other reasons.

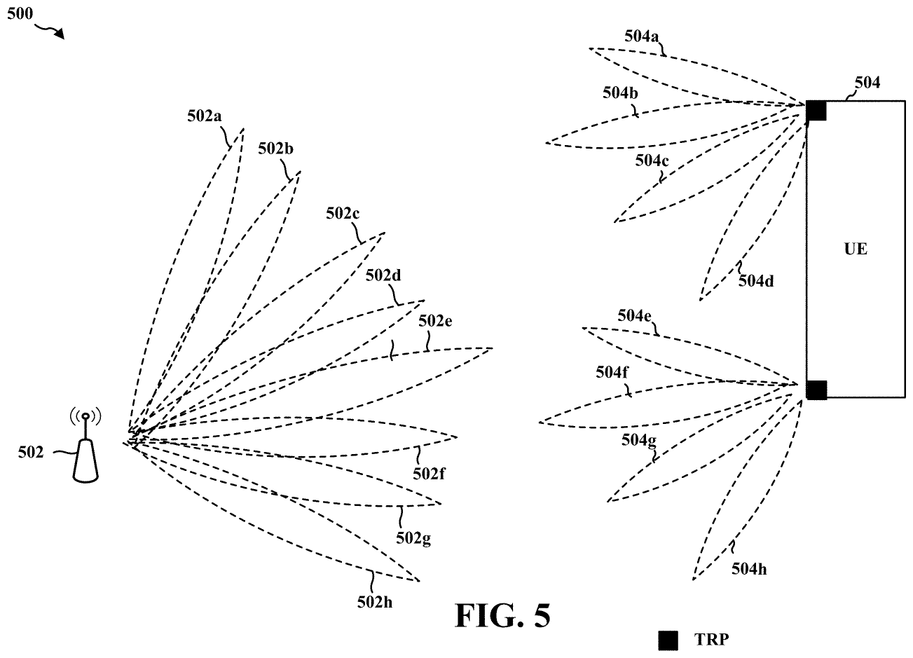

FIG. 5 is a diagram 500 illustrating a base station in communication with a UE via multiple beams. Referring to FIG. 5, the base station 502 may transmit a beamformed signal to the UE 504 in one or more of the directions 502a, 502b, 502c, 502d, 502e, 502f, 502g, 502h. The UE 504 may receive the beamformed signal from the base station 502 in one or more receive directions 504a, 504b, 504c, 504d. The UE 504 may also transmit a beamformed signal to the base station 502 in one or more of the directions 504a-504d. The base station 502 may receive the beamformed signal from the UE 504 in one or more of the receive directions 502a-502h. The base station 502/UE 504 may perform beam training to determine the best receive and transmit directions for each of the base station 502/UE 504. The transmit and receive directions for the base station 502 may or may not be the same. The transmit and receive directions for the UE 504 may or may not be the same. As illustrated in FIG. 5, the UE may have more than one TRP. FIG. 5 illustrates a first TRP with associated beams 504a-d and a second TRP with associated beams 504e, 504f, 504g, 504h.

The UE 504 may monitor the quality of the beams that it uses for communication with a base station. For example, the UE 504 may monitor a quality of a signal received via reception beam(s). A BFD procedure may be used to identify problems in beam quality and BFR may be used when a beam failure is detected. For monitoring active link performances, the UE 504 may perform measurements of at least one signal, e.g., reference signals, for beam failure detection. The measurements may include measuring a RSRP strength of a reference signal, such as a BFD RS configured by the base station 502.

Thresholds may be defined in tracking the radio link conditions, the threshold(s) may correspond to an RSRP that indicates a beam failure condition. When the measured RSRP of the BFD RS falls below the threshold for a defined a period of time, the UE 504 may determine that a beam failure is detected.

When a beam failure is detected, the UE 504 may take appropriate actions to recover the connection. For example, the UE 504 may transmit a BFR request to the base station 502 to initiate the recovery of the connection. The base station 502 and UE 504 may start the BFR process accordingly.

The BFR procedure may be configured on a per cell basis. The base station may configure a set of BFD RS for a cell for the UE to monitor. The UE may measure the RSRP of the set of BFD RS in order to determine if a condition for BFD is detected for the cell. Once BFR is detected for the cell, the UE may send the BFR request to the base station in order to perform beam failure recovery for the cell. The base station and UE may then perform the BFR process for the cell, e.g., including performing random access for BFR.

For multiple-TRP (mTRP) UEs, because different TRPs may experience a channel differently, beam failure may occur on one TRP but not on another TRP. Therefore, it may be advantageous to perform per-TRP BFR. Aspects provided herein provide configurations for per-TRP BFR. In some aspects, for per-TRP BFR, the base station may configure dedicated BFD RS and resources for the BFR process for each TRP of the UE. Thus, the UE may receive a separate BFR configuration for different TRPs of the UE, e.g., for each TRP of the UE in some aspects. In other words, in some aspects, the BFR process may be per beam group that includes beams from a same TRP. Additionally, in some aspects, the BFR process may be per beam group that includes beams from different TRPs. The separate configurations for different TRPs of the UE enables TRP/beam group specific BFD. The separate configurations for different TRPs of the UE enables TRP/beam group specific new candidate beam identification. The separate configurations for different TRPs of the UE enables a TRP/beam group specific beam failure recovery request (BFRQ). The separate configurations for different TRPs of the UE enables improved response by the base station to the BFD request from the UE, as separate BFR configurations enable the base station to individually address a beam failure at a particular TRP or for a particular beam group. The UE may apply QCL/spatial relation assumptions for a particular TRP/beam group, e.g., after receiving the base station response to a BFR request for the TRP/beam group. The UE may apply uplink power control for downlink or uplink channels or reference signals after receiving the base station response to a BFR request for a particular TRP/beam group.

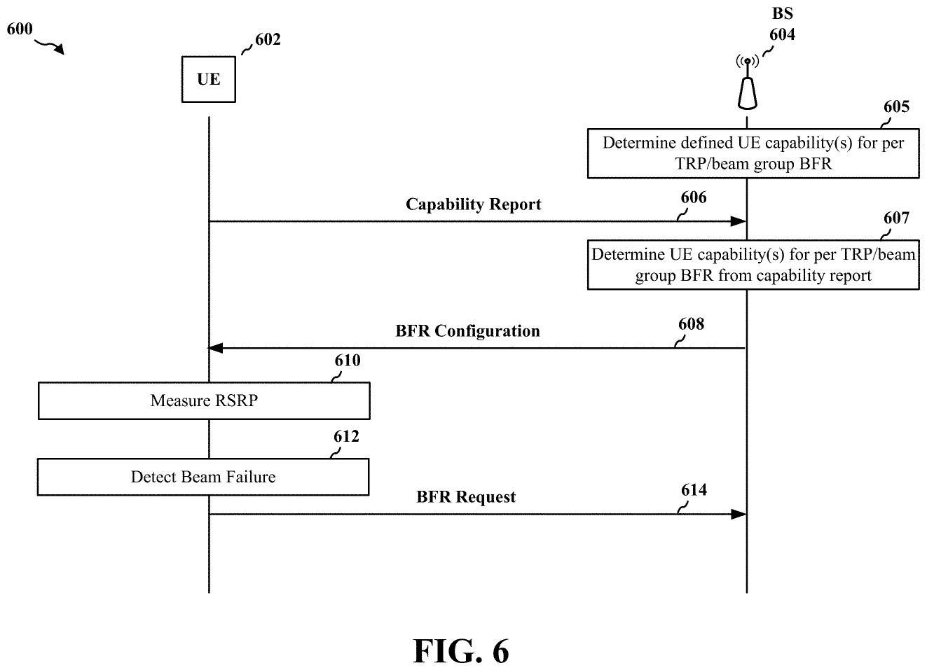

FIG. 6 is a call flow diagram 600 of signaling between a UE 602 and a base station 604. In order to configure per-TRP/per beam group BFR, the base station 604 may use information regarding parameters of UE capability. The parameters may include one or more of: the supported maximum number of BFD RS set (each TRP/beam group will be mapped to one BFD RS), the supported maximum number of BFD RS per set, the supported maximum number of total BFD RSs across all sets, or the like. In some aspects, each parameter may be per component carrier (CC) basis, per bandwidth part (BWP) basis, or for all CCs. In some aspects, the base station 604 may identify one or more of the parameters based on parameters defined for the UE that the base station may be already aware of without additionally signaling from the UE. For example, at 605, the base station 604 may determine a defined parameter for the UE 602 for per-TRP/beam group BFR. Alternatively, or additionally, as illustrated in FIG. 6, the UE 602 may transmit a capability report 606 indicating one or more parameters of UE capability to the base station 604. For example, the base station 604 may determine one or more parameters for per-TRP/beam group BFR, at 607, based on the information received from the UE 602, e.g., in the capability report 606. In some examples, the base station 604 may determine the UE's capabilities based on a combination of 605 and 607. As an example, the base station may identify that a maximum of three BFD RS per set is allowed for the UE based on defined information while receiving other parameters in the capability report 606. In some aspects, the capability report 606 is transmitted via radio resource control (RRC) signaling. In some aspects, each parameter in the capability report 606 corresponds to an information element (IE) in RRC. In some aspects, the UE 602 may also indicate, in the capability report 606, that if per-TRP/beam group BFR is supported or not for the UE 602 or not. In some aspects, if a max of one BFD RS set is supported, then it may implicitly indicate that the UE 602 cannot support per-TRP/beam group BFR. The base station 604 may accordingly avoid configuring per-TRP/beam group BFD RS for the UE.

In some aspects, the base station 604 may transmit BFR configuration 608 that includes per-TRP/beam group BFD RS to the UE 602. In some aspects, base station 604 may transmit BFR configuration 608 that includes per-TRP/beam group BFD RS to the UE 602 based on the previously described parameters and capability. The UE 602 may measure RSRP at 610 and may accordingly detect beam failure 612 as previously described. Upon detecting a beam failure 612, the UE 602 may transmit a BFR request 614 to the base station 604. In some aspects, the per-TRP/per beam group BFR may be for intra-cell mTRP or inter-cell mTRP. In some aspects, for inter-cell mTRP, the per-TRP/per beam group BFR may be additionally per-cell.

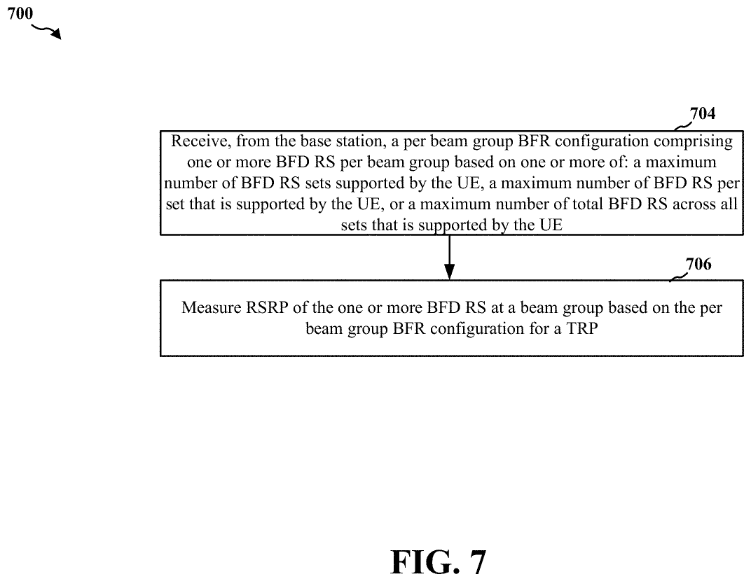

FIG. 7 is a flowchart 700 of a method of wireless communication. The method may be performed by a UE that includes one or more TRPs and one or more beam groups (e.g., the UE 104, the UE 402, 408, 410, the UE 504, the UE 602; the apparatus 1102).

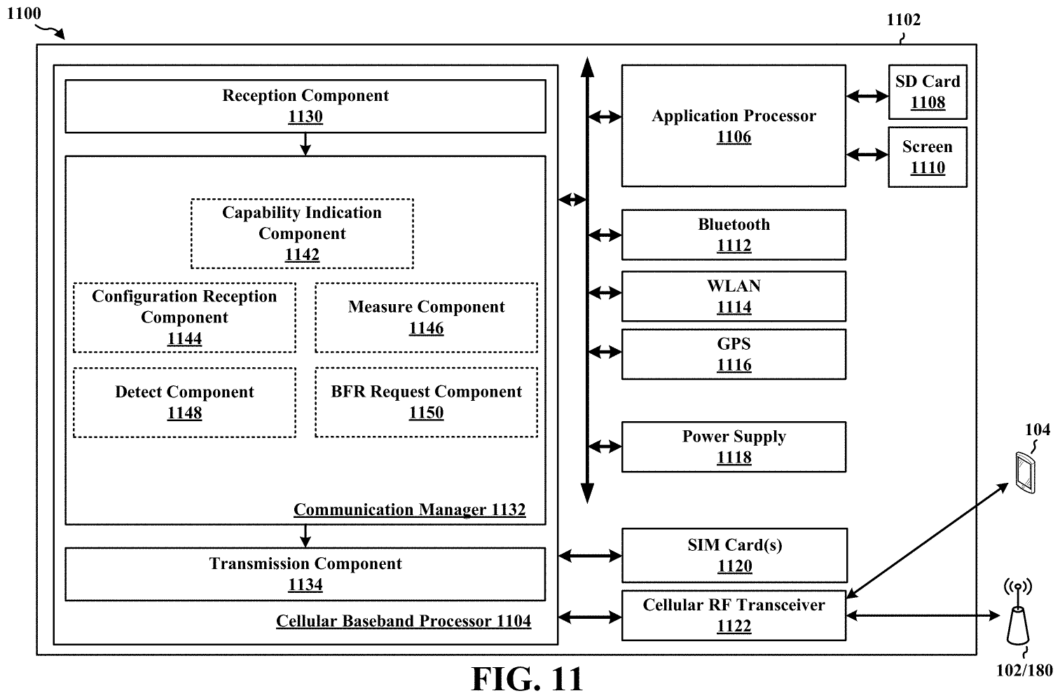

At 704, the UE may receive, from the base station, a per beam group BFR configuration comprising one or more BFD RS per beam group based on one or more of: a maximum number of BFD RS sets supported by the UE, a maximum number of BFD RS per set that is supported by the UE, or a maximum number of total BFD RS across each set that is supported by the UE. In some aspects, 704 may be performed by configuration reception component 1144 in FIG. 11. The per beam group BFR configuration may correspond with the BFR configuration 608 described in connection with FIG. 6. In some aspects, each BFD RS set corresponds to the beam group. In some aspects, each beam group in the one or more beam groups correspond to the TRP. In some aspects, the per beam group BFR configuration is based on the maximum number of BFD RS sets supported by the UE. In some aspects, the maximum number of BFD RS sets is supported by the UE for a CC of the UE. In some aspects, the maximum number of BFD RS sets is supported by the UE for a BWP of the UE. In some aspects, the maximum number of BFD RS sets is supported by the UE for each CC configured for the UE. In some aspects, the per beam group BFR configuration is based on the maximum number of BFD RS per set supported by the UE. In some aspects, the maximum number of BFD RS per set is supported by the UE for a CC of the UE. In some aspects, the maximum number of BFD RS per set is supported by the UE for a BWP of the UE. In some aspects, the maximum number of BFD RS per set is supported by the UE for each CC configured for the UE. In some aspects, the per beam group BFR configuration is based on the maximum number of total BFD RS across each set supported by the UE. In some aspects, the maximum number of total BFD RS across each set is supported by the UE for a CC of the UE. In some aspects, the maximum number of total BFD RS across each set is supported by the UE for a BWP of the UE. In some aspects, the maximum number of total BFD RS across each set is supported by the UE for each CC configured for the UE.

At 706, the UE may measure RSRP of the one or more BFD RS at a beam group based on the per beam group BFR configuration for a TRP. In some aspects, 706 may be performed by measure component 1146 in FIG. 11. The measuring may correspond with the measure RSRP 610 described in connection with FIG. 6.

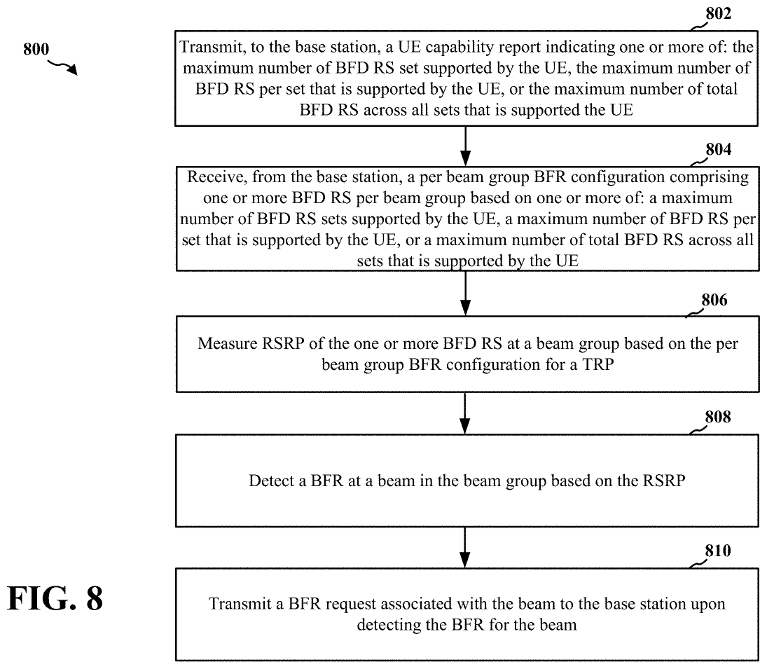

FIG. 8 is a flowchart 800 of a method of wireless communication. The method may be performed by a UE that includes one or more TRPs and one or more beam groups (e.g., the UE 104, the UE 402, 408, 410, the UE 504, the UE 602; the apparatus 1102).

At 802, the UE may transmit, to a base station, a UE capability report indicating one or more of: the maximum number of BFD RS set supported by the UE, the maximum number of BFD RS per set that is supported by the UE, or the maximum number of total BFD RS across each set that is supported the UE. In some aspects, 802 may be performed by capability indication component 1142 in FIG. 11. In some aspects, the UE transmits the UE capability report via RRC signaling. In some aspects, the UE capability report further indicates whether the UE supports per beam group BFR. The UE capability report may correspond with the capability report 606 described in connection with FIG. 6.

At 804, the UE may receive, from the base station, a per beam group BFR configuration comprising one or more BFD RS per beam group based on one or more of: a maximum number of BFD RS sets supported by the UE, a maximum number of BFD RS per set that is supported by the UE, or a maximum number of total BFD RS across each set that is supported by the UE. In some aspects, 804 may be performed by configuration reception component 1144 in FIG. 11. The per beam group BFR configuration may correspond with the BFR configuration 608 described in connection with FIG. 6. In some aspects, each BFD RS set corresponds to the beam group. In some aspects, each beam group in the one or more beam groups correspond to the TRP. In some aspects, the per beam group BFR configuration is based on the maximum number of BFD RS sets supported by the UE. In some aspects, the maximum number of BFD RS sets is supported by the UE for a CC of the UE. In some aspects, the maximum number of BFD RS sets is supported by the UE for a BWP of the UE. In some aspects, the maximum number of BFD RS sets is supported by the UE for each CC configured for the UE. In some aspects, the per beam group BFR configuration is based on the maximum number of BFD RS per set supported by the UE. In some aspects, the maximum number of BFD RS per set is supported by the UE for a CC of the UE. In some aspects, the maximum number of BFD RS per set is supported by the UE for a BWP of the UE. In some aspects, the maximum number of BFD RS per set is supported by the UE for each CC configured for the UE. In some aspects, the per beam group BFR configuration is based on the maximum number of total BFD RS across each set supported by the UE. In some aspects, the maximum number of total BFD RS across each set is supported by the UE for a CC of the UE. In some aspects, the maximum number of total BFD RS across each set is supported by the UE for a BWP of the UE. In some aspects, the maximum number of total BFD RS across each set is supported by the UE for each CC configured for the UE.

At 806, the UE may measure RSRP of the one or more BFD RS at a beam group based on the per beam group BFR configuration for a TRP. In some aspects, 806 may be performed by measure component 1146 in FIG. 11. The measuring may correspond with the measure RSRP 610 described in connection with FIG. 6.

At 808, the UE may detect a beam failure at a beam in the beam group based on the RSRP. In some aspects, 808 may be performed by detect component 1148 in FIG. 11. 808 may correspond with the detect beam failure 610 described in connection with FIG. 6.

At 810, the UE may transmit a BFR request associated with the beam to the base station upon detecting the beam failure for the beam. In some aspects, 810 may be performed by BFR request component 1150 in FIG. 11. The BFR request may correspond with the BFR request 614 described in connection with FIG. 6.

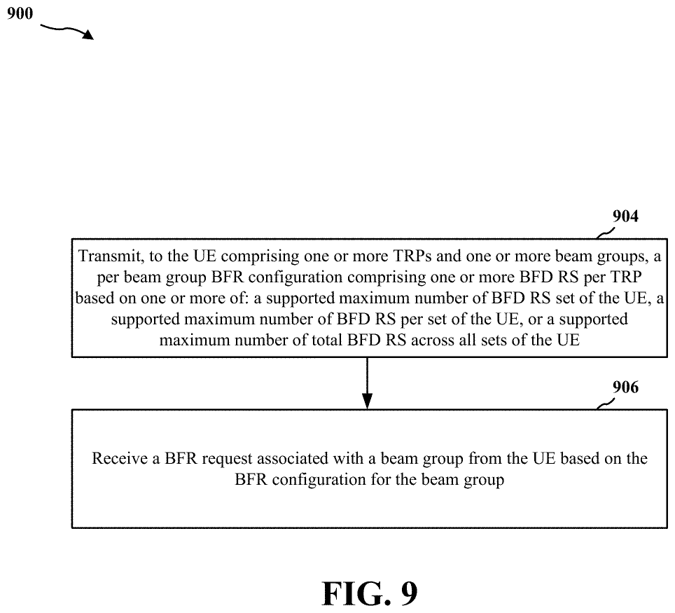

FIG. 9 is a flowchart 900 of a method of wireless communication. The method may be performed by a base station (e.g., the base station 102/180, the base station 502, the base station 604; the apparatus 1202).

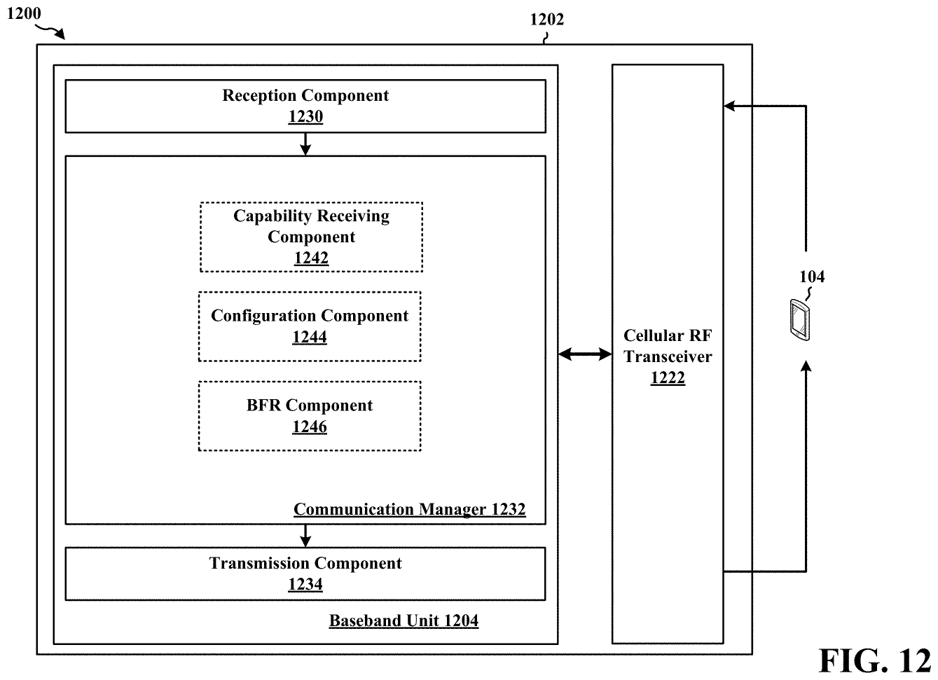

At 904, the base station may transmit, to the UE comprising one or more TRPs and one or more beam groups, a per beam group BFR configuration comprising one or more BFD RS per TRP based on one or more of: a supported maximum number of BFD RS set of the UE, a supported maximum number of BFD RS per set of the UE, or a supported maximum number of total BFD RS across each set of the UE. In some aspects, 902 may be performed by configuration component 1244 in FIG. 12. In some aspects, each BFD RS set corresponds to the beam group. In some aspects, each beam group in the one or more beam groups correspond to the TRP. In some aspects, at least one of the maximum number of BFD RS sets supported by the UE, the maximum number of BFD RS per set that is supported by the UE, or the maximum number of total BFD RS across each set that is supported by the UE is based on a defined parameter. In some aspects, the per beam group BFR configuration is based on one or more parameter received in the UE capability report and at least one parameter that is defined for the UE. In some aspects, the per beam group BFR configuration is based on the maximum number of BFD RS sets supported by the UE. In some aspects, the maximum number of BFD RS sets is supported by the UE for a CC of the UE. In some aspects, the maximum number of BFD RS sets is supported by the UE for a BWP of the UE. In some aspects, the maximum number of BFD RS sets is supported by the UE for each CC configured for the UE. In some aspects, the per beam group BFR configuration is based on the maximum number of BFD RS per set supported by the UE. In some aspects, the maximum number of BFD RS per set is supported by the UE for a CC of the UE. In some aspects, the maximum number of BFD RS per set is supported by the UE for a BWP of the UE. In some aspects, the maximum number of BFD RS per set is supported by the UE for each CC configured for the UE. In some aspects, the per beam group BFR configuration is based on the maximum number of total BFD RS across each set supported by the UE. In some aspects, the maximum number of total BFD RS across each set is supported by the UE for a CC of the UE. In some aspects, the maximum number of total BFD RS across each set is supported by the UE for a BWP of the UE. In some aspects, the maximum number of total BFD RS across each set is supported by the UE for each CC configured for the UE.

At 906, the base station may receive a BFR request associated with a beam group from the UE based on the BFR configuration for the beam group. In some aspects, 902 may be performed by BFR component 1246 in FIG. 12.

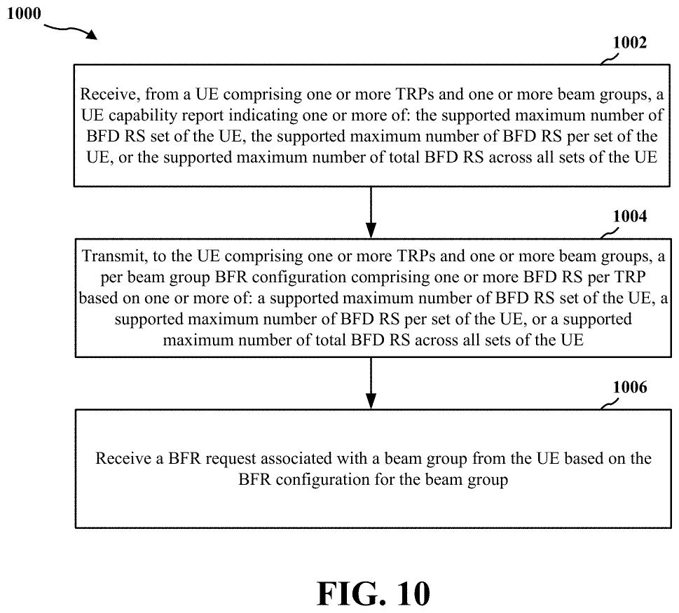

FIG. 10 is a flowchart 1000 of a method of wireless communication. The method may be performed by a base station (e.g., the base station 102/180, the base station 502, the base station 604; the apparatus 1202).

At 1002, the base station may receive, from a UE comprising one or more TRPs and one or more beam groups, a UE capability report indicating one or more of: the supported maximum number of BFD RS set of the UE, the supported maximum number of BFD RS per set of the UE, or the supported maximum number of total BFD RS across each set of the UE. In some aspects, 1002 may be performed by capability receiving component 1242 in FIG. 12. In some aspects, the base station receives the UE capability report via RRC signaling. In some aspects, the UE capability report further indicates whether the UE supports per beam group BFR.

At 1004, the base station may transmit, to the UE comprising one or more TRPs and one or more beam groups, a per beam group BFR configuration comprising one or more BFD RS per TRP based on one or more of: a supported maximum number of BFD RS set of the UE, a supported maximum number of BFD RS per set of the UE, or a supported maximum number of total BFD RS across each set of the UE. In some aspects, 1002 may be performed by configuration component 1244 in FIG. 12. In some aspects, each BFD RS set corresponds to the beam group. In some aspects, each beam group in the one or more beam groups correspond to the TRP. In some aspects, at least one of the maximum number of BFD RS sets supported by the UE, the maximum number of BFD RS per set that is supported by the UE, or the maximum number of total BFD RS across each set that is supported by the UE is based on a defined parameter. In some aspects, the per beam group BFR configuration is based on one or more parameter received in the UE capability report and at least one parameter that is defined for the UE. In some aspects, the per beam group BFR configuration is based on the maximum number of BFD RS sets supported by the UE. In some aspects, the maximum number of BFD RS sets is supported by the UE for a CC of the UE. In some aspects, the maximum number of BFD RS sets is supported by the UE for a BWP of the UE. In some aspects, the maximum number of BFD RS sets is supported by the UE for each CC configured for the UE. In some aspects, the per beam group BFR configuration is based on the maximum number of BFD RS per set supported by the UE. In some aspects, the maximum number of BFD RS per set is supported by the UE for a CC of the UE. In some aspects, the maximum number of BFD RS per set is supported by the UE for a BWP of the UE. In some aspects, the maximum number of BFD RS per set is supported by the UE for each CC configured for the UE. In some aspects, the per beam group BFR configuration is based on the maximum number of total BFD RS across each set supported by the UE. In some aspects, the maximum number of total BFD RS across each set is supported by the UE for a CC of the UE. In some aspects, the maximum number of total BFD RS across each set is supported by the UE for a BWP of the UE. In some aspects, the maximum number of total BFD RS across each set is supported by the UE for each CC configured for the UE.

At 1006, the base station may receive a BFR request associated with a beam group from the UE based on the BFR configuration for the beam group. In some aspects, 1002 may be performed by BFR component 1246 in FIG. 12.

FIG. 11 is a diagram 1100 illustrating an example of a hardware implementation for an apparatus 1102. The apparatus 1102 is a UE and includes a cellular baseband processor 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the additional modules of the apparatus 1102.

The communication manager 1132 may include a capability indication component 1142 that is configured to transmit, to the base station, a UE capability report indicating one or more of: the maximum number of BFD RS set supported by the UE, the maximum number of BFD RS per set that is supported by the UE, or the maximum number of total BFD RS across each set that is supported the UE, e.g., as described in connection with 802 in FIG. 8. The communication manager 1132 may further include a configuration reception component 1144 that is configured to receive, from the base station, a per beam group BFR configuration comprising one or more BFD RS per beam group based on one or more of: a maximum number of BFD RS sets supported by the UE, a maximum number of BFD RS per set that is supported by the UE, or a maximum number of total BFD RS across each set that is supported by the UE, e.g., as described in connection with 804 in FIGS. 8 and 704 in FIG. 7. The communication manager 1132 may further include a measure component 1146 that is configured to measure RSRP of the one or more BFD RS at a beam group based on the per beam group BFR configuration for a TRP, e.g., as described in connection with 806 in FIGS. 8 and 706 in FIG. 7. The communication manager 1132 may further include a detect component 1148 that is configured to detecting a beam failure at a beam in the beam group based on the RSRP, e.g., as described in connection with 808 in FIG. 8. The communication manager 1132 may further include a BFR request component 1150 that is configured to transmit a BFR request associated with the beam to the base station upon detecting the beam failure for the beam, e.g., as described in connection with 810 in FIG. 8.

The apparatus may include additional components that perform each of the blocks of the algorithm in the flowcharts of FIGS. 7-8. As such, each block in the flowcharts of FIGS. 7-8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for receiving, from a base station, a per beam group BFR configuration comprising one or more BFD RS per beam group based on one or more of: a maximum number of BFD RS sets supported by the UE, a maximum number of BFD RS per set that is supported by the UE, or a maximum number of total BFD RS across each set that is supported by the UE. The cellular baseband processor 1104 may further include means for measuring RSRP of the one or more BFD RS at a beam group based on the per beam group BFR configuration for a TRP. The cellular baseband processor 1104 may further include means for detecting a beam failure at a beam in the beam group based on the RSRP. The cellular baseband processor 1104 may further include means for transmitting a BFR request associated with the beam to the base station upon detecting the beam failure for the beam. The cellular baseband processor 1104 may further include means for transmitting, to the base station, a UE capability report indicating one or more of: the maximum number of BFD RS set supported by the UE, the maximum number of BFD RS per set that is supported by the UE, or the maximum number of total BFD RS across each set that is supported the UE.

The means may be one or more of the components of the apparatus 1102 configured to perform the functions recited by the means. As described supra, the apparatus 1102 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 12 is a diagram 1200 illustrating an example of a hardware implementation for an apparatus 1202. The apparatus 1202 is a BS and includes a baseband unit 1204. The baseband unit 1204 may communicate through a cellular RF transceiver 1222 with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the base station 310 and may include the memory 376 and/or at least one of the TX processor 316, the RX processor 370, and the controller/processor 375.

The communication manager 1232 may include a capability receiving component 1242 that is configured to receive, from a UE comprising one or more TRPs and one or more beam groups, a UE capability report indicating one or more of: the supported maximum number of BFD RS set of the UE, the supported maximum number of BFD RS per set of the UE, or the supported maximum number of total BFD RS across each set of the UE, e.g., as described in connection with 1002 in FIG. 10. The communication manager 1232 may further include a configuration component 1244 that is configured to transmit, to the UE comprising one or more TRPs and one or more beam groups, a per beam group BFR configuration comprising one or more BFD RS per TRP based on one or more of: a supported maximum number of BFD RS set of the UE, a supported maximum number of BFD RS per set of the UE, or a supported maximum number of total BFD RS across each set of the UE, e.g., as described in connection with 1004 in FIGS. 10 and 904 in FIG. 9. The communication manager 1232 may further include a BFR component 1246 that is configured to receive a BFR request associated with a beam group from the UE based on the BFR configuration for the beam group, e.g., as described in connection with 1006 in FIGS. 10 and 906 in FIG. 9.

The apparatus may include additional components that perform each of the blocks of the algorithm in the flowcharts of FIG. 9-10. As such, each block in the flowcharts of FIG. 9-10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for transmitting, to a UE comprising one or more TRPs and one or more beam groups, a per beam group BFR configuration comprising one or more BFD RS per TRP based on one or more of: a supported maximum number of BFD RS set of the UE, a supported maximum number of BFD RS per set of the UE, or a supported maximum number of total BFD RS across each set of the UE. The baseband unit 1204 may further include means for receiving a BFR request associated with a beam group from the UE based on the BFR configuration for the beam group.

The means may be one or more of the components of the apparatus 1002 configured to perform the functions recited by the means. As described supra, the apparatus 1002 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE comprising one or more TRPs and one or more beam groups, comprising: receiving, from a base station, a per beam group BFR configuration comprising one or more BFD RS per beam group based on one or more of: a maximum number of BFD RS sets supported by the UE, a maximum number of BFD RS per set that is supported by the UE, or a maximum number of total BFD RS across each set that is supported by the UE; and measuring RSRP of the one or more BFD RS at a beam group based on the per beam group BFR configuration for a TRP.

Aspect 2 is the method of aspect 1, further comprising: detecting a beam failure at a beam in the beam group based on the RSRP; and transmitting a BFR request associated with the beam to the base station upon detecting the beam failure for the beam.

Aspect 3 is the method of any of aspects 1-2, wherein each BFD RS set corresponds to the beam group.

Aspect 4 is the method of any of aspects 1-3, wherein each beam group in the one or more beam groups correspond to the TRP.

Aspect 5 is the method of any of aspects 1-4, further comprising: transmitting, to the base station, a UE capability report indicating one or more of: the maximum number of BFD RS set supported by the UE, the maximum number of BFD RS per set that is supported by the UE, or the maximum number of total BFD RS across each set that is supported the UE.

Aspect 6 is the method of any of aspects 1-5, wherein the UE transmits the UE capability report via RRC signaling.

Aspect 7 is the method of any of aspects 1-6, wherein the UE capability report further indicates whether the UE supports per beam group BFR.

Aspect 8 is the method of any of aspects 1-7, wherein the per beam group BFR configuration is based on the maximum number of BFD RS sets supported by the UE.

Aspect 9 is the method of any of aspects 1-8, wherein the maximum number of BFD RS sets is supported by the UE for a CC of the UE.

Aspect 10 is the method of any of aspects 1-8, wherein the maximum number of BFD RS sets is supported by the UE for a BWP of the UE.

Aspect 11 is the method of any of aspects 1-8, wherein the maximum number of BFD RS sets is supported by the UE for each CC configured for the UE.

Aspect 12 is the method of any of aspects 1-11, wherein the per beam group BFR configuration is based on the maximum number of BFD RS per set supported by the UE.

Aspect 13 is the method of any of aspects 1-12, wherein the maximum number of BFD RS per set is supported by the UE for a CC of the UE.

Aspect 14 is the method of any of aspects 1-12, wherein the maximum number of BFD RS per set is supported by the UE for a BWP of the UE.

Aspect 15 is the method of any of aspects 1-12, wherein the maximum number of BFD RS per set is supported by the UE for each CC configured for the UE.

Aspect 16 is the method of any of aspects 1-15, wherein the per beam group BFR configuration is based on the maximum number of total BFD RS across each set supported by the UE.

Aspect 17 is the method of any of aspects 1-16, wherein the maximum number of total BFD RS across each set is supported by the UE for a CC of the UE.

Aspect 18 is the method of any of aspects 1-16, wherein the maximum number of total BFD RS across each set is supported by the UE for a BWP of the UE.

Aspect 19 is the method of any of aspects 1-16, wherein the maximum number of total BFD RS across each set is supported by the UE for each CC configured for the UE.

Aspect 20 is a method of wireless communication at a base station, comprising: transmitting, to a UE comprising one or more TRPs and one or more beam groups, a per beam group BFR configuration comprising one or more BFD RS per TRP based on one or more of: a supported maximum number of BFD RS set of the UE, a supported maximum number of BFD RS per set of the UE, or a supported maximum number of total BFD RS across each set of the UE; and receiving a BFR request associated with a beam group from the UE based on the BFR configuration for the beam group.

Aspect 21 is the method of aspect 20, wherein each BFD RS set corresponds to the beam group.

Aspect 22 is the method of any of aspects 20-21, wherein each beam group in the one or more beam groups correspond to a TRP.

Aspect 23 is the method of any of aspects 20-22, wherein at least one of the maximum number of BFD RS sets supported by the UE, the maximum number of BFD RS per set that is supported by the UE, or the maximum number of total BFD RS across each set that is supported by the UE is based on a defined parameter.

Aspect 24 is the method of any of aspects 20-23, further comprising: receiving, from the UE, a UE capability report indicating one or more of: the supported maximum number of BFD RS set of the UE, the supported maximum number of BFD RS per set of the UE, or the supported maximum number of total BFD RS across each set of the UE.

Aspect 25 is the method of any of aspects 20-24, wherein the per beam group BFR configuration is based on one or more parameter received in the UE capability report and at least one parameter that is defined for the UE.

Aspect 26 is the method of any of aspects 20-25, wherein the base station receives the UE capability report via RRC signaling.

Aspect 27 is the method of any of aspects 20-26, wherein the UE capability report further indicates whether the UE supports per beam group BFR.

Aspect 28 is the method of any of aspects 20-27, wherein the per beam group BFR configuration is based on the maximum number of BFD RS sets supported by the UE.

Aspect 29 is the method of any of aspects 20-28, wherein the maximum number of BFD RS sets is supported by the UE for a CC of the UE.

Aspect 30 is the method of any of aspects 20-28, wherein the maximum number of BFD RS sets is supported by the UE for a BWP of the UE.

Aspect 31 is the method of any of aspects 20-28, wherein the maximum number of BFD RS sets is supported by the UE for each CC configured for the UE.

Aspect 32 is the method of any of aspects 20-31, wherein the per beam group BFR configuration is based on the maximum number of BFD RS per set supported by the UE.

Aspect 33 is the method of any of aspects 20-32, wherein the maximum number of BFD RS per set is supported by the UE for a CC of the UE.

Aspect 34 is the method of any of aspects 20-32, wherein the maximum number of BFD RS per set is supported by the UE for a BWP of the UE.

Aspect 35 is the method of any of aspects 20-32, wherein the maximum number of BFD RS per set is supported by the UE for each CC configured for the UE.

Aspect 36 is the method of any of aspects 20-35, wherein the per beam group BFR configuration is based on the maximum number of total BFD RS across each set supported by the UE.

Aspect 37 is the method of any of aspects 20-36, wherein the maximum number of total BFD RS across each set is supported by the UE for a CC of the UE.

Aspect 38 is the method of any of aspects 20-36, wherein the maximum number of total BFD RS across each set is supported by the UE for a BWP of the UE.

Aspect 39 is the method of any of aspects 20-36, wherein the maximum number of total BFD RS across each set is supported by the UE for each CC configured for the UE.

Aspect 40 is an apparatus for wireless communication including at least one processor coupled to a memory and configured to implement a method as in any of aspects 1 to 19.

Aspect 41 is an apparatus for wireless communication including at least one processor coupled to a memory and configured to implement a method as in any of aspects 20 to 39.

Aspect 42 is an apparatus for wireless communication including means for implementing a method as in any of aspects 1 to 19.

Aspect 43 is an apparatus for wireless communication including means for implementing a method as in any of aspects 20 to 39.

Aspect 44 is a computer-readable medium storing computer executable code, where the code when executed by a processor causes the processor to implement a method as in any of aspects 1 to 19.

Aspect 45 is a computer-readable medium storing computer executable code, where the code when executed by a processor causes the processor to implement a method as in any of aspects 20 to 39.

What is claimed is:

1. A method of wireless communication at a user equipment (UE) comprising one or more transmission and reception points (TRPs) and one or more beam groups, comprising:
receiving, from a base station, a per beam group beam failure recovery (BFR) configuration comprising one or more beam failure detection (BFD) reference signal (RS) per beam group based on one or more of: a maximum number of BFD RS sets supported by the UE, a maximum number of BFD RS per set that is supported by the UE, or a maximum number of total BFD RS across each set that is supported by the UE; and
measuring reference signal received power (RSRP) of the one or more BFD RS at a beam group based on the per beam group BFR configuration for a TRP.

2. The method of claim 1, wherein the per beam group BFR configuration is based on the maximum number of BFD RS per set supported by the UE.

3. The method of claim 2, wherein the maximum number of BFD RS per set is supported by the UE for a component carrier (CC) of the UE.

4. The method of claim 2, wherein the maximum number of BFD RS per set is supported by the UE for a bandwidth part (BWP) of the UE.

5. The method of claim 2, wherein the maximum number of BFD RS per set is supported by the UE for each component carrier (CC) configured for the UE.

6. The method of claim 1, further comprising:
detecting a beam failure at a beam in the beam group based on the RSRP; and
transmitting a BFR request associated with the beam to the base station upon detecting the beam failure for the beam.

7. The method of claim 1, wherein each BFD RS set corresponds to the beam group.

8. The method of claim 1, wherein each beam group in the one or more beam groups correspond to the TRP.

9. The method of claim 1, further comprising:
transmitting, to the base station, a UE capability report indicating one or more of: the maximum number of BFD RS set supported by the UE, the maximum number of BFD RS per set that is supported by the UE, or the maximum number of total BFD RS across each set that is supported the UE.

10. The method of claim 9, wherein the UE transmits the UE capability report via radio resource control (RRC) signaling.

11. The method of claim 9, wherein the UE capability report further indicates whether the UE supports per beam group BFR.

12. The method of claim 1, wherein the per beam group BFR configuration is based on the maximum number of BFD RS sets supported by the UE.

13. The method of claim 1, wherein the per beam group BFR configuration is based on the maximum number of total BFD RS across each set supported by the UE.

14. A method of wireless communication at a base station, comprising:
transmitting, to a user equipment (UE) comprising one or more transmission and reception points (TRPs) and one or more beam groups, a per beam group beam failure recovery (BFR) configuration comprising one or more beam failure detection (BFD) reference signal (RS) per TRP based on one or more of: a supported maximum number of BFD RS set of the UE, a supported maximum number of BFD RS per set of the UE, or a supported maximum number of total BFD RS across each set of the UE; and
receiving a BFR request associated with a beam group from the UE based on the BFR configuration for the beam group.

15. The method of claim 14, wherein the per beam group BFR configuration is based on the maximum number of BFD RS per set supported by the UE.

16. The method of claim 14, wherein the maximum number of BFD RS per set is supported by the UE for a component carrier (CC) of the UE.

17. The method of claim 14, wherein the maximum number of BFD RS per set is supported by the UE for a bandwidth part (BWP) of the UE.

18. The method of claim 14, wherein the maximum number of BFD RS per set is supported by the UE for each component carrier (CC) configured for the UE.

19. An apparatus for wireless communication at a user equipment (UE) comprising one or more transmission and reception points (TRPs) and one or more beam groups, comprising:
a memory; and
at least one processor coupled to the memory and configured to:
receive, from a base station, a per beam group beam failure recovery (BFR) configuration comprising one or more beam failure detection (BFD) reference signal (RS) per beam group based on one or more of: a maximum number of BFD RS sets supported by the UE, a maximum number of BFD RS per set that is supported by the UE, or a maximum number of total BFD RS across each set that is supported by the UE; and
measure reference signal received power (RSRP) of the one or more BFD RS at a beam group based on the per beam group BFR configuration for a TRP.

20. The apparatus of claim 19, wherein the per beam group BFR configuration is based on the maximum number of BFD RS per set supported by the UE.

21. The apparatus of claim 20, wherein the maximum number of BFD RS per set is supported by the UE for a component carrier (CC) of the UE.

22. The apparatus of claim 20, wherein the maximum number of BFD RS per set is supported by the UE for a bandwidth part (BWP) of the UE.

23. The apparatus of claim 20, wherein the maximum number of BFD RS per set is supported by the UE for each component carrier (CC) configured for the UE.

24. The apparatus of claim 19, wherein the at least one processor is further configured to:
detect a beam failure at a beam in the beam group based on the RSRP; and
transmit a BFR request associated with the beam to the base station upon detecting the beam failure for the beam.

25. The apparatus of claim 19, wherein each BFD RS set corresponds to the beam group.

26. The apparatus of claim 19, wherein each beam group in the one or more beam groups correspond to the TRP.

27. The apparatus of claim 19, wherein the at least one processor is further configured to:
transmit, to the base station, a UE capability report indicating one or more of: the maximum number of BFD RS set supported by the UE, the maximum number of BFD RS per set that is supported by the UE, or the maximum number of total BFD RS across each set that is supported the UE.

28. The apparatus of claim 19, further comprising a transceiver coupled to the at least one processor.

29. An apparatus for wireless communication at a base station, comprising:
a memory; and
at least one processor coupled to the memory and configured to:
transmit, to a user equipment (UE) comprising one or more transmission and reception points (TRPs) and one or more beam groups, a per beam group beam failure recovery (BFR) configuration comprising one or more beam failure detection (BFD) reference signal (RS) per TRP based on one or more of: a supported maximum number of BFD RS set of the UE, a supported maximum number of BFD RS per set of the UE, or a supported maximum number of total BFD RS across each set of the UE; and
receive a BFR request associated with a beam group from the UE based on the BFR configuration for the beam group.

30. The apparatus of claim 29, further comprising a transceiver coupled to the at least one processor.
